(19) United States
(12) Patent Application Publication
(10) Pub. No.: US 2007/0273369 A1
(43) Pub. Date: Nov. 29, 2007

(54) Magnetic rotating device

(76) Inventor: Ta Sheng Huang, Miao Li Hsien (TW)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 11/440,157

(22) Filed: May 25, 2006

(51) Int. Cl. G01B 7/30

(52) U.S. Cl. 324/207.25

(57) ABSTRACT

The invention relates to a magnetic rotating device. The magnetic rotating device comprises: a base, a spindle, a rotating plate, a shell body, an elastic element, a passive magnetic element, an adjusting device and a driving device. The passive magnetic element and the driving device have the same magnetic pole to generate a magnetic repulsive force for driving the passive magnetic element to shift so as to drive the rotating plate. Furthermore, the magnetic rotating device of the invention utilizes the permanent magnetic force of the driving device and the passive magnetic element to drive the rotating plate rotate continuously without inputting any external force. Therefore, by utilizing the magnetic rotating device, energy resources can be saved.

### BACKGROUND OF THE INVENTION

1. Field of the Invention

The present invention relates to a rotating device, particularly to a magnetic rotating device.

2. Description of the Related Art

In view of the law of conservation of energy, energy cannot be produced or destroyed. Therefore, to make a device rotate, energy must be inputted that is higher than the friction. In a no input-energy situation, gravity, a spring and a magnet are often considered as energy sources to rotate a device. However, without any input energy or special mechanical design, the energy from gravity, a spring and a magnet cannot rotate a device eternally.

Accordingly, many inventors still endeavor to develop a device that can rotate eternally, using the energy sources of gravity, a spring and a magnet. Based on gravity, a spring and a magnet, many special mechanical structures have been designed to obtain the object of rotating a device eternally. However, there has been no successful case up to now.

Therefore, it is necessary to provide a magnetic rotating device so as to obtain the object of rotating a device eternally.

### SUMMARY OF THE INVENTION

One objective of the present invention is to provide a magnetic rotating device. The magnetic rotating device comprises: a base, a spindle, a rotating plate, a shell body, an elastic element, a passive magnetic element, an adjusting device and a driving device. The base has an opening. The spindle is disposed through the opening and has a first end and a second end. The rotating plate is disposed at the first end of the spindle. The shell body is disposed at the second end of the spindle. The elastic element has a third end and a fourth end. The third end is disposed at the axial position of the shell body. The elastic element and a stretching line from the spindle form an angle. The passive magnetic element is disposed at the fourth end of the elastic element. The adjusting device is disposed on the shell body and is perpendicular to the stretching line from the spindle. The driving device has the same magnetic pole as that of the passive magnetic element to generate a magnetic repulsive force for driving the passive magnetic element to shift so as to drive the rotating plate.

Another objective of the present invention is to provide a magnetic rotating device. The magnetic rotating device comprises: a base, a spindle, a rotating plate, a shell body, a plurality of elastic elements, a plurality of passive magnetic elements and a driving device. The base has an opening. The spindle is disposed through the opening and has a first end and a second end. The rotating plate is disposed at the first end of the spindle. The shell body is disposed at the second end of the spindle. Each elastic element has a third end and a fourth end. The third end is disposed at the shell body. The elastic element and a stretching line from the spindle form an angle. The passive magnetic elements are disposed at the fourth end of each elastic element respectively. The driving device has the same magnetic pole as that of the passive magnetic elements to generate a magnetic repulsive force for driving the passive magnetic element to shift so as to drive the rotating plate.

Since the driving device has the same magnetic pole as that of the passive magnetic elements, the magnetic rotating device of the invention can utilize the magnetic repulsive force to drive the passive magnetic element to shift so as to drive the magnetic rotating device. Also, by utilizing the adjusting device, the rotating plate has different rotating inertia, and the rotating stability can be improved. Furthermore, the magnetic rotating device of the invention utilizes the permanent magnetic force of the driving device and the passive magnetic element to drive the rotating plate rotate continuously without inputting any external force. Therefore, by utilizing the magnetic rotating device, energy resources can be saved.

### BRIEF DESCRIPTION OF THE DRAWINGS

FIG. 1 shows the magnetic rotating device according to a first embodiment of the invention;

FIG. 2 shows the front sectional view of the magnetic rotating device according to the invention;

FIG. 3 shows the shell body having a plurality of second weighting elements according to the invention;

FIG. 4A shows the magnetic driving element according to the invention;

FIG. 4B shows the sectional view of the magnetic driving element according to the invention;

FIG. 5 shows the magnetic rotating device in rotation according to the invention; and

FIG. 6 shows the magnetic rotating device according to a second embodiment of the invention.

### DETAILED DESCRIPTION OF THE INVENTION

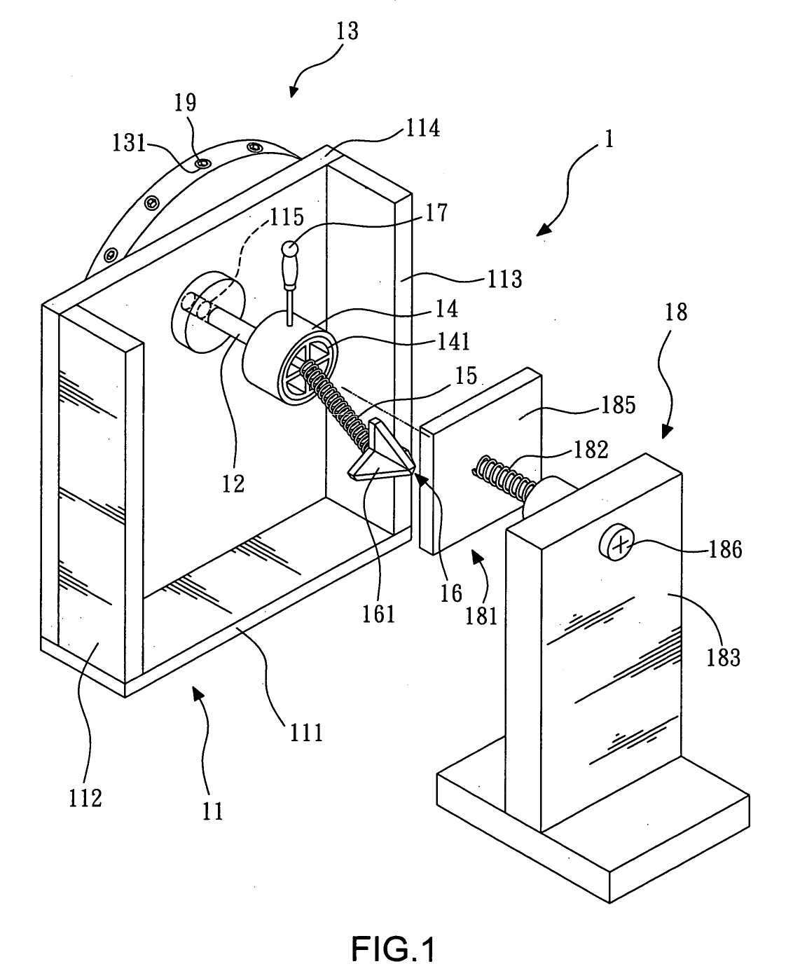

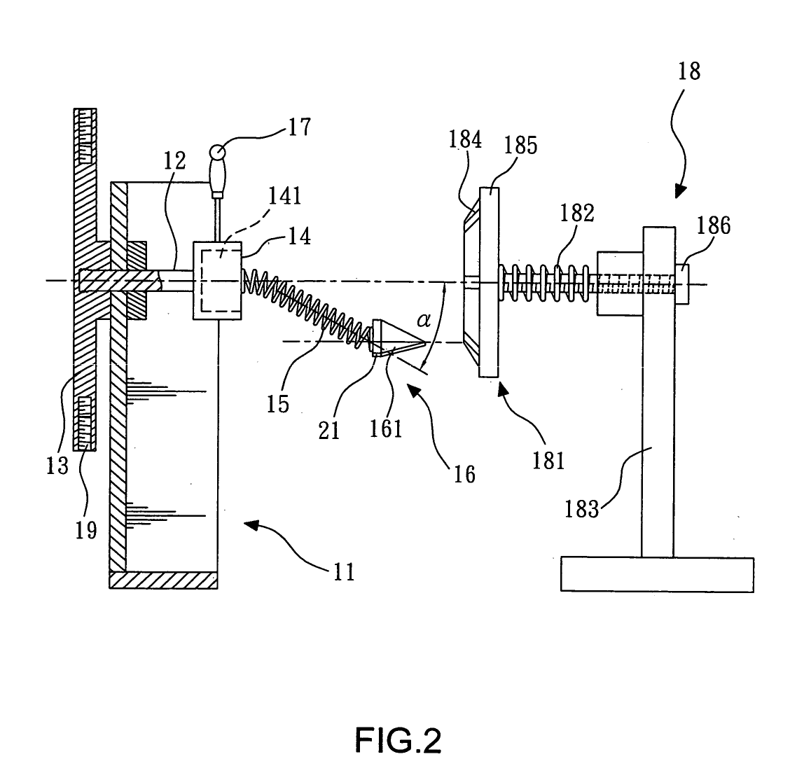

Referring to FIG. 1 and FIG. 2, they show the magnetic rotating device of a first embodiment according to the invention. The magnetic rotating device 1 comprises a base 11, a spindle 12, a rotating plate 13, a shell body 14, an elastic element 15, a passive magnetic element 16, an adjusting device 17 and a driving device 18. The base 11 has a bottom plate 111, two first sidewalls 112, 113 and a second sidewall 114. The first sidewalls 112, 113 are correspondingly disposed on both sides of the bottom plate 111, and the second sidewall 114 is fixed between the first sidewalls 112, 113. In addition, the second sidewall 114 has an opening 115. In the embodiment, the second sidewall 114 is fixed between the first sidewalls 112, 113 by using a screwing method. It can be noticed that the second sidewall 114 is not limited to be fixed between the first sidewalls 112, 113 by using the screwing method. The second sidewall 114 can be fixed between the first sidewalls 112, 113 by using other methods.

The spindle 12 is disposed through the opening 115 and has a first end and a second end. The second end is corresponding to the first end. The rotating plate 13 is disposed on the first end of the spindle 12. The rotating plate 13 is driven by the spindle 12. The rotating plate 13 has a plurality of first containing portions 131. The first containing portions 131 are disposed on the circumambiency of the rotating plate 13 by an angle, and the angles between each first containing portion 131 are equal. The first containing portions 131 are used to contain a plurality of first weighting elements 19 so as to adjust the balance of the magnetic rotating device 1. In the embodiment, the first weighting elements 19 are screws, and the shape of the first containing portion 131 matches the shape of the first weighting element 19, so that the depth of the screws can be adjusted so as to balance the magnetic rotating device 1. Therefore, by utilizing the first weighting elements 19, the rotating plate 13 has a bigger rotating inertia, and the stability of the magnetic rotating device 1 will be increased.

The shell body 14 is disposed at the second end of the spindle 12. The shell body 14 and the rotating plate 13 are disposed on two corresponding sides of the second sidewall 114 respectively. The shell body 14 is driven by the spindle 12. The shell body 14 has at least one second weighting element 141 to balance the magnetic rotating device 1. The second weighting element 141 cooperates with the shell body 14 and the rotating plate 13 so that the rotating plate 13 has a bigger rotating inertia, and the rotating stability of the magnetic rotating device 1 will be increased. In the embodiment, one second weighting element 141 is described as an example. The second weighting element 141 is a ring-shaped structure and is disposed in the shell body 14.

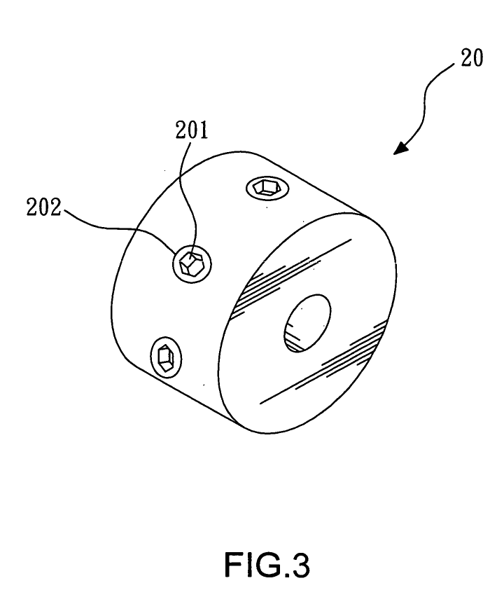

Referring to FIG. 3, the shell body 20 may have a plurality of second containing portions 202 and second weighting elements 201. The second containing portions 202 are used to contain the second weighting elements 201. The method for disposing the second weighting elements 201 is the same as that for disposing the first weighting elements 19 in the above-mentioned FIG. 1.

Referring to FIG. 1 again, the elastic element 15 has a third end and a fourth end. The third end is disposed at the axial position of the shell body 14. The elastic element 15 and the stretching line from the spindle 12 form an angle α. In the embodiment, the elastic element 15 is a spring. In an other embodiment, the elastic element 15 may be made of any elastic material.

The passive magnetic element 16 is disposed at the fourth end of the elastic element 15 by using a fixing plate 21. The angle α is between 30 degrees and 45 degrees. The passive magnetic element 16 comprises at least one first magnetic element. In the embodiment, the passive magnetic element 16 is designed to be composed of three first magnetic elements 161. Each first magnetic element 161 has a bevel, and the bevel is formed between two magnetic poles. One of the magnetic poles is cut along the bevel, and most of the magnetic pole is removed. The first magnetic elements 161 have the same magnetic pole and are disposed by equal angles (in the embodiment, the angle is 120 degrees) to form the passive magnetic element 16. The passive magnetic element 16 extends away from the elastic element 15 in the direction of a stretching line that is parallel to the stretching line of the spindle 12. The passive magnetic element 16 has a stronger magnetic force on one magnetic pole (for example: N pole). Since the first magnetic elements 161 are disposed by equal angles, there are equal magnetic repulsive forces caused by the driving device 18 and the passive magnetic element 16, so that the rotating plate 13 rotates more stably.

The adjusting device 17 is disposed on the shell body 14 and is perpendicular to the stretching line from the spindle 12. The length of the adjusting device 17 can be adjusted so as to balance the magnetic rotating device 1. By adjusting the length of the adjusting device 17, the rotating plate 13 has a different rotating inertia. The inertia is transmitted from the shell body 14 to the spindle 12, and finally to the rotating plate 13. Therefore, the length of the adjusting device 17 can be adjusted according to various needs, so that the rotating plate 13 has various rotating inertias, and the rotating stability can be improved.

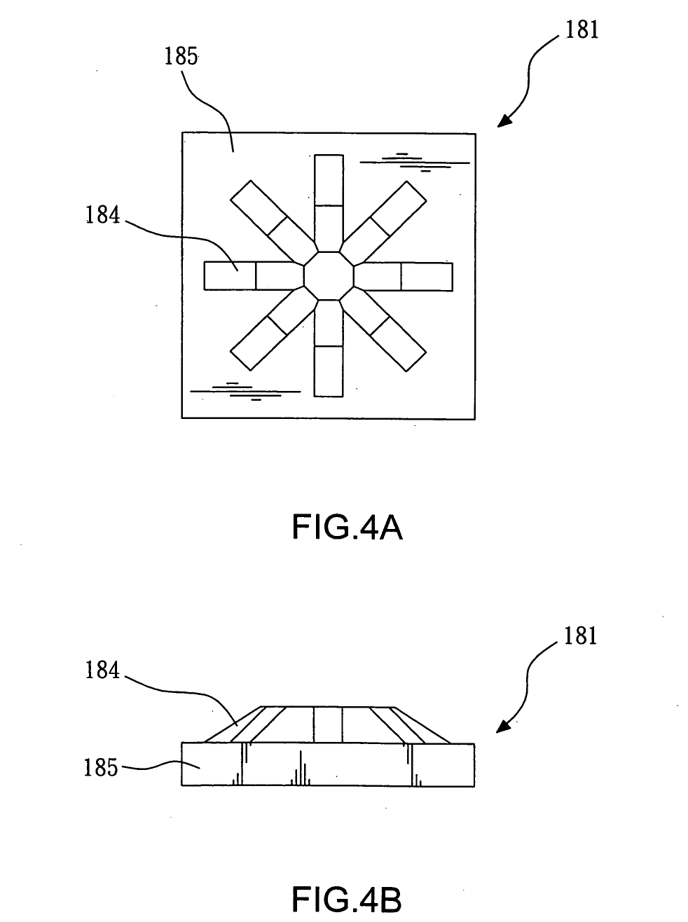

Referring to FIG. 1 and FIG. 4A, the driving device 18 has a magnetic driving element 181, an elastic supporting element 182 and a stand 183. The magnetic driving element 181 is disposed at one end of the elastic supporting element 182, and the other end of the elastic supporting element 182 is disposed at the stand 183. In the embodiment, the elastic supporting element 182 is a spring. The magnetic driving element 181 comprises a plurality of second magnetic elements 184 (in the embodiment, the magnetic driving element 181 comprises eight second magnetic elements 184) and a plate 185. The second magnetic elements 184 are disposed on the plate 185 by equal angles. In the embodiment, the plate 185 is an aluminum alloy. Each second magnetic element 184 has a bevel, and the bevel is formed between two magnetic poles. One of the magnetic poles is cut along the bevel, and most of the magnetic pole is removed, as shown in FIG. 4B. However, the magnetic driving element 181 is not limited to comprise eight second magnetic elements 184, it may comprise six second magnetic elements or other amount of second magnetic elements.

The driving device 18 further comprises an adjusting element 186. According to various practice, the adjusting element 186 can be a screw. The adjusting element 186 is disposed in the elastic supporting element 182, and one end of the adjusting element 186 is disposed at the stand 183. The magnetic driving element 181 is disposed on the other end of the adjusting element 186. The adjusting element 186 is used to adjust the length of the elastic supporting element 182.

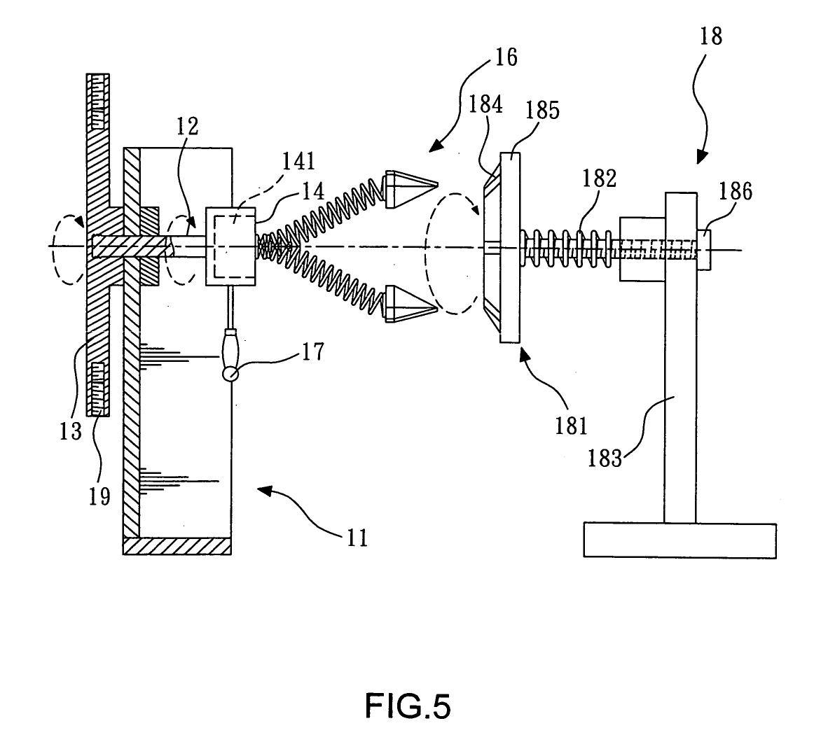

By moving the stand 183, the distance between the magnetic driving element 181 and the passive magnetic element 16 can be adjusted. The magnetic driving element 181 of the driving device 18 and the passive magnetic element 16 have the same magnetic pole (for example: N pole). The magnetic driving element 181 is disposed on the stretching line from the spindle 12, so that the magnetic repulsive force can drive the passive magnetic element 16 to shift so as to drive the rotating plate 13, as shown in FIG. 5.

The degree of the magnetic repulsive force is defined by the magnetic force between the magnetic driving element 181 and the passive magnetic element 16. When the magnetic driving element 181 is at a suitable distance from the passive magnetic element 16 after moving the stand 183, the rotating plate 13 rotates. It can be noticed that the distance between the magnetic driving element 181 and the passive magnetic element 16 should not be too small.

The magnetic rotating device 1 of the invention utilizes the driving device 18 to drive the passive magnetic element 16 having the same pole as the driving device 18 to shift so as to drive the spindle 12 and the rotating plate 13. In addition, the magnetic rotating device 1 utilizes the first weighting elements 19, the second weighting elements 141 and the adjusting element 17, so that the rotating plate 13 has various rotating inertias, and the rotating stability can be improved. Furthermore, the magnetic rotating device 1 of the invention utilizes the permanent magnetic force of the driving device 18 and the passive magnetic element 16 to drive the rotating plate 13 rotate continuously without inputting any external force. Also, the spindle 12 can connect to a coupled device so as to output the rotating kinetic energy of the magnetic rotating device 1. Therefore, by utilizing the magnetic rotating device 1, energy resources can be saved.

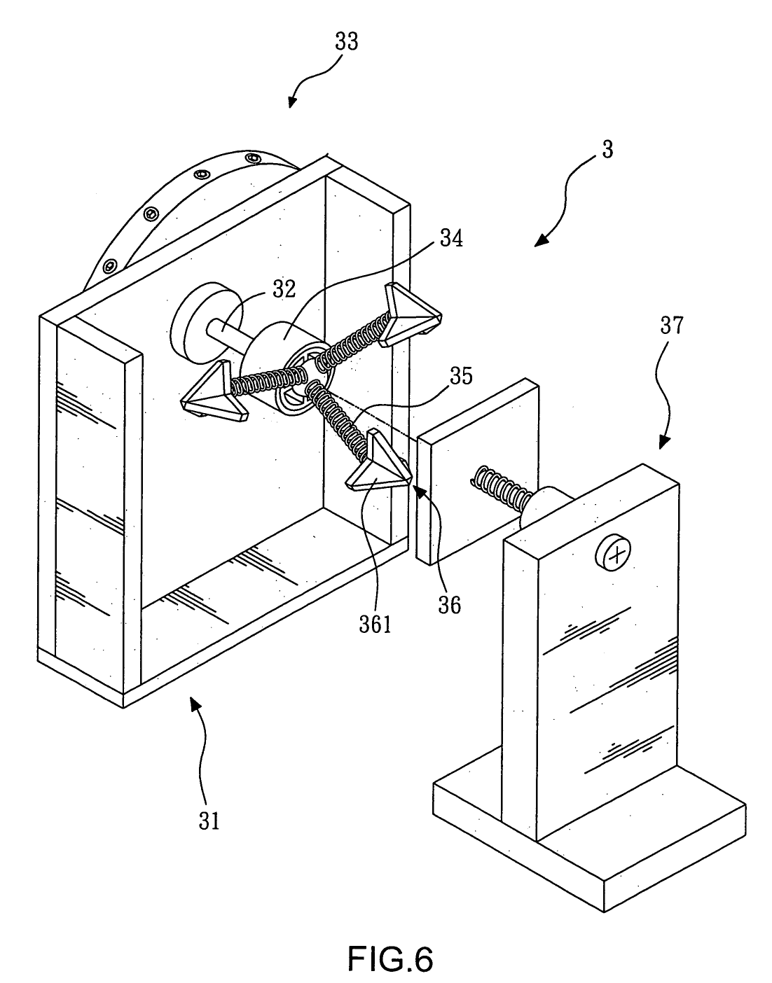

Referring to FIG. 6, it shows the magnetic rotating device according to a second embodiment of the invention. The magnetic rotating device 3 comprises a base 31, a spindle 32, a rotating plate 33, a shell body 34, a plurality of elastic elements 35, a plurality of passive magnetic elements 36 and a driving device 37. The differences between the magnetic rotating device 3 of the second embodiment and the magnetic rotating device 1 of the first embodiment in FIG. 1 are that the magnetic rotating device 3 does not have the adjusting device (as shown in FIG. 1) and has a plurality of elastic elements 35 and a plurality of passive magnetic elements 36 (the magnetic rotating device 1 of the first embodiment only has a elastic element 15 and a passive magnetic element 16). Since the other elements of the magnetic rotating device 3 are described in the first embodiment, they will not be described in detail here.

The elastic elements 35 are disposed at the shell body 34 by equal angles. Each passive magnetic element 36 is disposed at one end of each elastic element 35. Each passive magnetic element 36, such as the passive magnetic element 16 in FIG. 1, is composed of three first magnetic elements 361. The first magnetic elements 361 are disposed by equal angles (in the embodiment, the angle is 120 degrees) to form the passive magnetic element 36. The passive magnetic element 36 extends away from the elastic element 15 in the direction of a stretching line that is parallel to the stretching line of the spindle 32.

The magnetic rotating device 3 of the second embodiment utilizes the permanent magnetic force of the driving device 37 and the passive magnetic element 36 to drive the rotating plate 33 rotate continuously without inputting any external force. Also, the spindle 12 can connect to a coupled device so as to output the rotating kinetic energy of the magnetic rotating device 3. Therefore, by utilizing the magnetic rotating device 3, energy resources can be saved.

While embodiments of the present invention have been illustrated and described, various modifications and improvements can be made by those skilled in the art. The embodiment of the present invention is therefore described in an illustrative but not restrictive sense. It is intended that the present invention may not be limited to the particular forms as illustrated, and that all modifications which maintain the spirit and scope of the present invention are within the scope as defined in the appended claims.

What is claimed is:

1. A magnetic rotating device, comprising:
a base, having an opening;
a spindle, disposed through the opening and having a first end and a second end;
a rotating plate, disposed at the first end of the spindle;
a shell body, disposed at the second end of the spindle;
an elastic element, having a third end and a fourth end, the third end disposed at the axial position of the shell body, the elastic element and a stretching line from the spindle forming an angle;
a passive magnetic element, disposed at the fourth end of the elastic element;
an adjusting device, disposed on the shell body and perpendicular to the stretching line from the spindle; and
a driving device, having the same magnetic pole as that of the passive magnetic element to generate a magnetic repulsive force for driving the passive magnetic element to shift so as to drive the rotating plate.

2. The magnetic rotating device according to claim 1, further comprising a plurality of first weighting elements disposed on the circumambiency of the rotating plate by an angle, the angles between each first weighting element being equal, and the rotating plate having a plurality of first containing portions to contain the first weighting elements.

3. The magnetic rotating device according to claim 1, wherein the shell body has at least one second weighting element and at least one second containing portion, and the second containing portion is disposed around the shell body to contain the second weighting element.

4. The magnetic rotating device according to claim 1, wherein the second weighting element is a ring-shaped structure and is disposed in the shell body.

5. The magnetic rotating device according to claim 1, wherein the elastic element is a spring.

6. The magnetic rotating device according to claim 1, wherein the passive magnetic element comprises at least one first magnetic element, the first magnetic elements have the same magnetic pole and are disposed by equal angles to form the passive magnetic element, the passive magnetic element extends away from the elastic element in the direction of a stretching line that is parallel to the stretching line of the spindle, the first magnetic element has a bevel, the bevel is formed between two magnetic poles, one of the magnetic poles is cut along the bevel, and most of the magnetic pole is removed.

7. The magnetic rotating device according to claim 1, wherein the driving device has a magnetic driving element, an elastic supporting element and a stand, the magnetic driving element is disposed at one end of the elastic supporting element, the magnetic driving element has the same magnetic pole as that of the passive magnetic element, the other end of the elastic supporting element is disposed at the stand, the magnetic driving element is disposed on the stretching line from the spindle, and the distance between the magnetic driving element and the passive magnetic element can be adjusted by moving the stand.

8. The magnetic rotating device according to claim 7, wherein the magnetic driving element comprises a plurality of second magnetic elements and a plate, the second magnetic elements are disposed on the plate by equal angles, each second magnetic element has a bevel, the bevel is formed between two magnetic poles, one of the magnetic poles is cut along the bevel, and most of the magnetic pole is removed.

9. The magnetic rotating device according to claim 7, wherein the driving device further comprises an adjusting element to adjust the length of the elastic supporting element, the adjusting element is disposed in the elastic supporting element, one end of the adjusting element is disposed at the stand, and the magnetic driving element is disposed on the other end of the adjusting element.

10. The magnetic rotating device according to claim 1, wherein the angle is between 30 degrees and 45 degrees.

11. A magnetic rotating device, comprising:
a base, having an opening;
a spindle, disposed through the opening and having a first end and a second end;
a rotating plate, disposed at the first end of the spindle;
a shell body, disposed at the second end of the spindle;
a plurality of elastic elements, each elastic element having a third end and a fourth end, the third end disposed at the axial position of the shell body, the elastic element and a stretching line from the spindle forming an angle;
a plurality of passive magnetic elements, disposed at the fourth end of each elastic element respectively; and
a driving device, having the same magnetic pole as that of the passive magnetic element to generate a magnetic repulsive force for driving the passive magnetic element to shift so as to drive the rotating plate.

12. The magnetic rotating device according to claim 11, further comprising a plurality of first weighting elements disposed on the circumambiency of the rotating plate by an angle, the angles between each first weighting element being equal, and the rotating plate having a plurality of first containing portions to contain the first weighting elements.

13. The magnetic rotating device according to claim 11, wherein the elastic elements are springs and are disposed at the shell body by equal angles.

14. The magnetic rotating device according to claim 11, wherein the shell body has at least one second weighting element and at least one second containing portion, and the second containing portion is disposed around the shell body to contain the second weighting element.

15. The magnetic rotating device according to claim 11, wherein the second weighting element is a ring-shaped structure and is disposed in the shell body.

16. The magnetic rotating device according to claim 11, wherein the passive magnetic element comprises at least one first magnetic element, the first magnetic elements have the same magnetic pole and are disposed by equal angles to form the passive magnetic element, the passive magnetic element extends away from the elastic element in the direction of a stretching line that is parallel to the stretching line of the spindle, the first magnetic element has a bevel, the bevel is formed between two magnetic poles, one of the magnetic poles is cut along the bevel, and most of the magnetic pole is removed.

17. The magnetic rotating device according to claim 11, wherein the driving device has a magnetic driving element, an elastic supporting element and a stand, the magnetic driving element is disposed at one end of the elastic supporting element, the magnetic driving element has the same magnetic pole as that of the passive magnetic element, the other end of the elastic supporting element is disposed at the stand, the magnetic driving element is disposed on the stretching line from the spindle, and the distance between the magnetic driving element and the passive magnetic element can be adjusted by moving the stand.

18. The magnetic rotating device according to claim 17, wherein the magnetic driving element comprises a plurality of second magnetic elements and a plate, the second magnetic elements are disposed on the plate by equal angles, each second magnetic element has a bevel, the bevel is formed between two magnetic poles, one of the magnetic poles is cut along the bevel, and most of the magnetic pole is removed.

19. The magnetic rotating device according to claim 17, wherein the driving device further comprises an adjusting element to adjust the length of the elastic supporting element, the adjusting element is disposed in the elastic supporting element, one end of the adjusting element is disposed at the stand, and the magnetic driving element is disposed on the other end of the adjusting element.

20. The magnetic rotating device according to claim 11, wherein the angle is between 30 degrees and 45 degrees.
